(19) United States
(12) Patent Application Publication
(10) Pub. No.: US 2009/0212524 A1
(43) Pub. Date: Aug. 27, 2009

(54) Push and Pull Vehicle by Stand-and-Sit Action

(76) Inventor: Rocky Jenlon Lee, Artesia, CA (US)

Correspondence Address: ROCKY JENLON LEE, 17716 BELSHIRE AVE, ARTESIA, CA, 90701, US

(21) Appl. No.: 12/391,261

(22) Filed: Feb. 24, 2009

Related U.S. Application Data
(63) Continuation-in-part of application No. 12/248,043, filed on Oct. 9, 2008.
(60) Provisional application No. 61/031,696, filed on Feb. 27, 2008.

(51) Int. Cl. B62M 1/20; B62M 1/04

(52) U.S. Cl. 280/226.1

(57) ABSTRACT

This invention A Push and Pull Vehicle by Stand-and-Sit Action provides a solid turning, fast reaction steering feeling as a regular bicycle while still able to push or to pull or do both to drive vehicle forward. It just works on opposite side force of pulling and pushing by stand-up and sit-down actions. It contains a handlebar with a steering column on steering, a treadle and a moving seat working together as leverage against each other, and with an increasing ratio device to magnify driving stroke and drives 2 one-way devices on rear wheel at a continuous cycle.

### CROSS REFERENCE TO RELATED APPLICATION

This application claims the benefit of and priority from U.S. provisional application No. 61/031,696 filed on Feb. 27, 2008, and continuation in part of U.S. non-provisional application Ser. No. 12/248,043 filed on Oct. 9, 2008

### BACKGROUND OF INVENTION

1. Field of the Invention

This invention relates to a push-and-pull action to power a vehicle or a vehicle powered by body weight action. Normally a push-and-pull vehicle's handlebar needs to do both on push-and-pull action and steering action; this complicates its steering mechanism. This invention works on opposite force of a push-and-pull vehicle: use a fixed position on hand and let body weight push on a moving seat or on a treadle, it is as same result as pushing or pulling by hands on a fixed body position. This invention achieves same result as a man powered push-pull vehicle and avoid its complicate steering mechanism; Since no push-pull involve on steering.

2. Brief Description of the Prior Art

The U.S. Pat. No. 5,192,089, Paddle Operate Scooter has a seesaw standing paddle, and uses one foot to push front end of the seesaw peddle and another foot push at rear end of the seesaw peddle, and each links to a chain to drive one-way sprocket at each side of rear wheel to power scooter forward.

Prior art needs a user stands at lateral posture because feet standing at a front-and-back direction while upper body and both hands are at left-and-right direction, this makes it difficult to maneuver, and get tired and uncomfortable at waist, shoulder and neck because keeping body on twisting posture all the time. Even though, steps on a seesaw peddle both sides only work on two legs mussel, it is nothing new other than a regular bicycle exercise, and get boring and uncomfortable very quick.

By adding a moving seat at rear end of the seesaw paddle, this invention design a user both hands pulling on handlebar together with feet both standing up naturally at front end of seesaw paddle to drive vehicle forward, and also both hands push handlebar, same time hip sits on said moving seat at rear end of seesaw paddle to drive vehicle forward continuously. This invention develops a rocking action which refers as a pushing-sitting and pulling-standing action hereafter. It uses hands, arms, stomach, waist, legs and feet all the time with a balanced posture, it makes vehicle running mostly by body weight, it is easy and faster speed, good exercise and fun.

### SUMMARY OF THE INVENTION

This invention A Push and Pull Vehicle by Stand-and-Sit Action solve above mentioned problems and provides a solid turning, fast reaction steering feeling as a regular bicycle. It focuses on opposite force of pulling and pushing; this gets same result as a push-and-pull action vehicle. It contains a handlebar with a steering column on steering, a treadle and a moving seat working together as leverage against each other, and output to an increasing ratio device to magnify driving stroke, and use two one-way devices to drive on rear wheel at a continuous cycle.

### BRIEF DESCRIPTION OF DRAWING

FIG. 1 shows this invention at end of pushing state.

FIG. 1a shows a change-direction mechanism by driving at outside of a chain loop.

FIG. 2 shows a binding mechanism on two pivotal shafts type at end of pushing-sitting state.

FIG. 3 shows this invention with a vertical moving seat type at end of pulling-standing-up state.

FIG. 4 shows top view of independent treadle pivot shaft and independent moving seat pivot shaft and with increasing gear ratio device and change-direction mechanism.

FIG. 5 shows a side view of a seesaw beam type, which moving seat with a big gear drives an increasing ratio device and drives on a derailer device.

FIG. 5a shows a side-view of changing direction by two meshing gears type.

FIG. 6 shows a transparent side view of a single pivot shaft type application.

FIG. 7 shows a top view of this invention with single pivot shaft and increasing ratio device.

FIG. 8 shows a side-view of a single treadle function apply on a bicycle application.

FIG. 9 shows a top-view of a single treadle function apply on a bicycle application.

FIG. 10 shows a side-view of a seesaw type on a bicycle application.

FIG. 11 shows a top-view of a seesaw type on a bicycle application.

FIG. 12 shows a foldable front wheel assembly and vertical treadle type with a seesaw angled beam.

### DRAWING NUMBER LIST

1 steering column, 3 front wheel, 5 chassis, 6 6a chain, 7 7a one-way device, 8 rear wheel, 14 handlebar, 25 increasing ratio device, 25a input gear, 25b 25c gear set, 41 42 stroke limiter, 43 peddle, 43a peddle shaft, 44 derailer chain, 45 one-way bearing, 51 53 gear, 55 chain, 55a 55b idler, 56 driven sprocket, 56a sprocket shaft, 56b big-sprocket set, 56c bearings, 60 A Push and Pull Vehicle by Stand-and-Sit Action, 61 Front wheel assembly, 61a steering mechanism, 63 rear wheel assembly, 63a derailer, 64 change-direction mechanism, 68 rocking device, 68a rocking output, 70 moving seat, 70a seat-arm, 70b seat-arm pivotal shaft, 70d fixed seat, 71 treadle, 71a treadle-arm, 71b treadle-arm pivotal shaft, 71d counterweight, 71e hooking-bar, 72 distributing shaft, 72a sprocket, 72b sprocket, 72c idler, 73 binding mechanism, 73a seesaw beam, 73b single pivotal shaft, 73c gear, 73d chain, 73e gear set, 73f gear, 74 sprocket, 75 shaft, 75a stopper cushion, 76 shaft, 77 gear, 78 shaft, 79 step gear, 80 sliding gear, 81 shifter, 82 shifter lock, 84 long key, 85 shaft sleeve, 86 pin, 87 nut, 88 gear section rack 88a small gear, 88b sprocket, 88c chain.

### DETAIL DESCRIPTION OF THE INVENTION

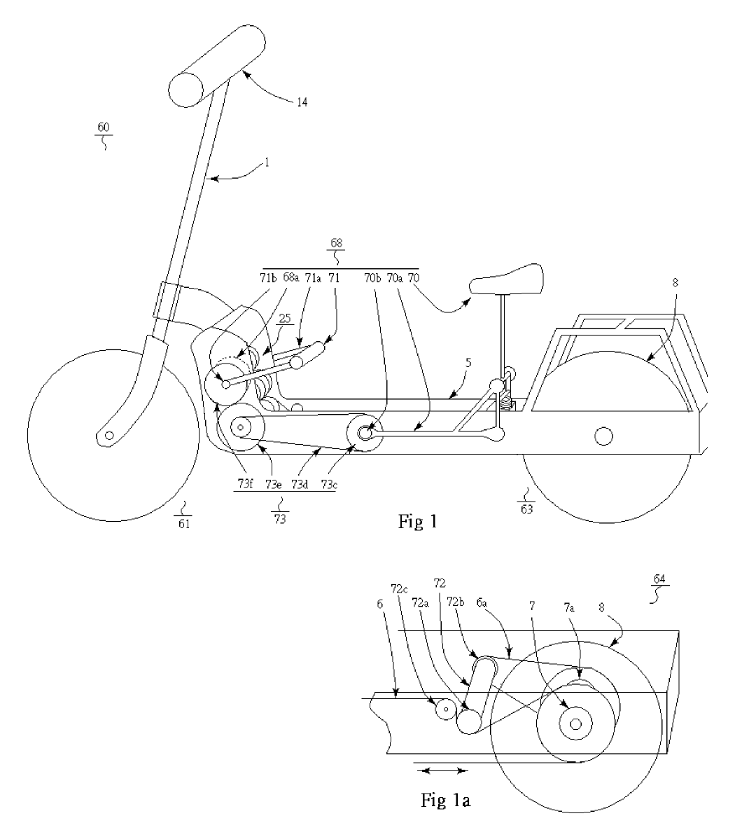

Refer to FIGS. 1 and 1a, A Push-and-Pull Vehicle by Stand-and-Sit Action 60, contains a frame or a chassis 5; a front wheel assembly 61 with a steering mechanism controlled by a handlebar 14 at front end of said chassis 5; a rear wheel assembly 63 with rear wheel(s) 8 driven by two one-way device 7, 7a; a rocking device 68 on said chassis 5 between front assembly 61 and rear wheel assembly 63, and contains a rocking driving means 68a to drive an increasing ratio device 25 and a change-direction mechanism 64 which contains one forward one reverse direction driving on said two one-way device 7, 7a respectively to drive rear wheel 8 forward;

Said rocking device 68 which contains a treadle 71 with leverage by treadle-arm 71a which having a pivotal shaft supported 71b by chassis 5, a moving seat 70 with a leverage by seat-arm 70a which having a pivotal shaft supported 70b by chassis 5; a binding mechanism 73 containing gears, timing gear, sprockets, chains etc. and connects said treadle-arm 71a and seat-arm 70a together to makes said treadle's torque against said moving seat's torque, treadle 71 down will cause moving seat 70 up, treadle 71 up will make moving seat 70 down; and a rocking driving means 68a on one of said pivotal shaft 70b 71b or said rocking driving means 68a under both torque arm 70b 71b and drive said increasing ratio device 25;

Said rocking driving means 68a includes a rotating means which rotates with said pivotal shaft, such as a gear 25a, a sprocket, a pulley, a timing gear or any rotating means on rocking pivotal shaft which connects its output driving power to said increasing ratio device's input shaft;

Said rocking driving means 68a also includes pulling means such as chain or cable under said treadle-arm and seat-arm; one pulling means links under treadle, another pulling matter links under moving seat, both pull means been guided by idlers to encircle inputs shaft rotating means of said increasing ratio device 25, and the other end of each said pulling means holds by a return spring on said chassis 5.

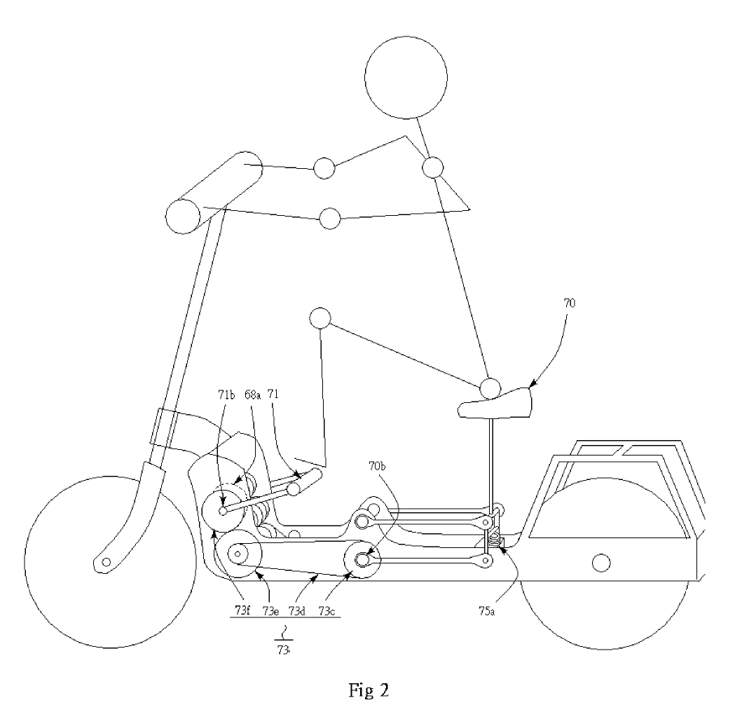

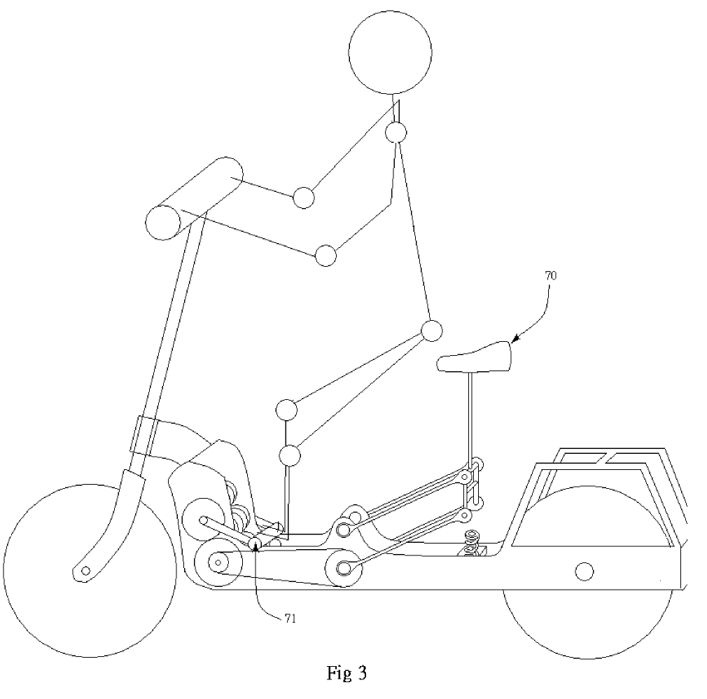

FIG. 2 shows a pushing-sitting action; whole body weight lands on moving seat 70 by hip and pushes said moving seat 70 down, by a binding means 73 to make rocking driving means 68a turning (this example is a rotating means as a gear on treadle pivotal shaft), and drives increasing ratio device 25, refer to FIG. 1a, it finally pulls chain 6 forward, which drives one-way sprocket 7 at one side of rear wheel 8 forward; distributing shaft 72 reverse its rotation because been driven by outside loop of chain 6 and cause chain 6a reverse direction which action is allowed by one-way device 7a; same time the treadle 71 has no body weight and been raised up by gear 73f which is driven by gear 73c to reset its cycle. FIG. 3 shows a pulling-standing action; whole body stand-up by feet and weight landing on the treadle 71, cause rocking output 68a (still a gear type in same example) reverse its rotation, also increasing ratio device 25 changes output direction, finally drives chain 6 moving backward; chain 6a become forward direction and drives one-way device 7a at another side of rear wheel 8 forward; same time the moving seat 70 has no body weight and is raised up by 73c which is driven by 73f; and cycle continues.

Said front wheel assembly 61 contains front wheel 3 and a well-known steering mechanism, it includes a single front wheel type as bicycle, tricycle which contain a handlebar 14, a steering column 1, a front wheel 3 on a front wheel fork; also includes a two-front wheel type vehicle as quads which contains a handlebar 14, a steering column 1, and linkages to link two front wheels moving together.

The rear wheel assembly 63 contains rear wheel 8, includes a single wheel type as bicycle, or a two-wheel type as a tricycle or a car type vehicle. It also may include a bicycle's derailer device 63a (or derailleur, which including big-sprocket set 56b, chain 44, position unit, one-way sprocket stack, controlling wire, and handle with indicator, all refer to derailer device.) to change rear wheel speed at handlebar area.

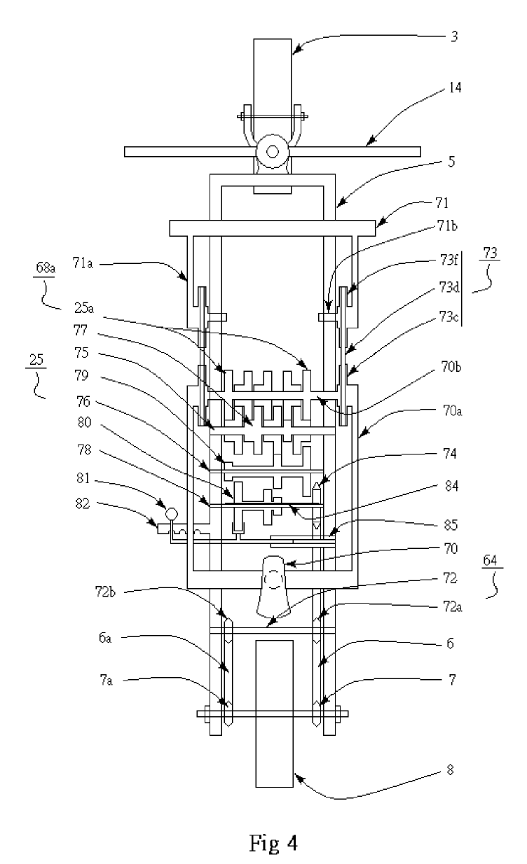

The chassis 5 holds the front wheel assembly 61, the pivot support for rocking device 68, increasing ratio device 25, change-direction mechanism 64 and the rear wheel assembly 63, also it supports some of the guide idler as needed; it can be any shape and size as needed. FIG. 4 shows, 2 parallel plates which allows treadle-arm and seat-arm at outside of frame, and let inside room for increasing gear ratio device and chains to drive rear gear (as illustrated) or vice versa or all inside. The chassis 5 also includes all kind of frame type as a single front-wheel as a scooter, bicycle, tricycle and two-front wheel type as a quads etc, all refer to the chassis 5.

The increasing ratio device 25 magnify rocking stroke big enough to speed up vehicle. which consists of a big gear together with a small gear as a gear set, and one set's big gear meshes another set's small gear, and continue this serial connection arrangement till reach to a gear ratio needed to match up the rear wheel dimension. If all gear sets are on two shaft, all gear sets are rotate freely on shaft, For example: rocking device make a 45 degree swing per 3 second from treadle 71 or moving seat 70, and generates 5 to 10 mile per hour speed on a 20″ rear wheel, it needs an increasing ratio over 6 times. Said gear sets include different type rotating means as sprockets and chains, pulleys and belts, timing gears and timing belts etc; also, it can be arranged at any suitable location to fit any type vehicle application, or be arranged a pre-increase ratio before reaching gear shifting device, such as bicycle derailer device 63a to select speed; this arrangement solves most of heavy load at beginning gears and make easy on down stream devices such as derail, gear shifting, one-way sprocket or one-way bearing etc. Gear may attach a sprocket to convert to a chain drive type to transmit power on a longer distance reason.

Said change-direction mechanism 64 make treadle and moving seat stroke both action active, normally is driven by said increasing ratio device 25, but it also can be arranged before increasing ratio device 25 to avoid power loss by inertia while reversing rotation. Said change-direction mechanism 64 diverts one power into two powers, one forward rotation driving on one of said two one-way devices, at same time, another reverse rotation driving on another of said two one-way devices, and use both one-way devices driving on a same output. There are many well-known ways to change rotation direction and a common one is adding one more gear on treadle action or on moving seat action before both reaching to one-way devices to drive rear wheel, and both reset by a return spring. This invention also uses following two ways to change direction as described.

FIG. 1a shows distributing shaft 72 contains two sprockets 72a and 72b at both end, one is driven by a driving chain from outside of chain loop, another sprocket transmits power by another chain from inside of chain loop; sprocket 72a been changed direction by connecting at outside loop of pulling chain 6 which powered from rocking device 68, another sprocket 72b connects inside loop of chain 6a to drive one-way device 7a at other side of rear wheel 8; idler 72c ensure the chain 6 engagement from sprocket 72a to one-way device 7 of rear wheel 8.

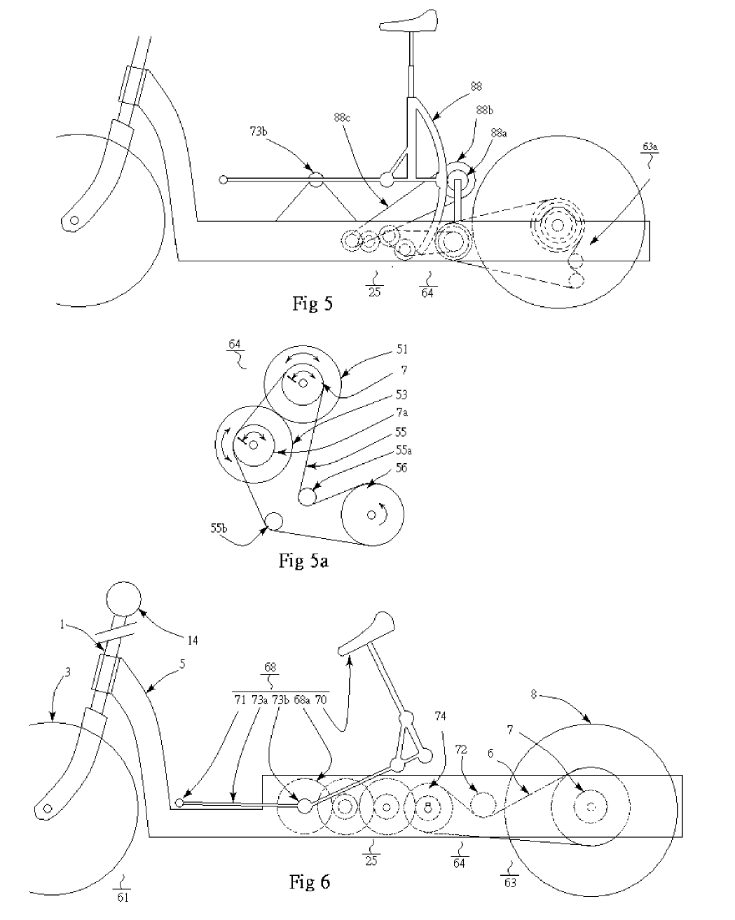

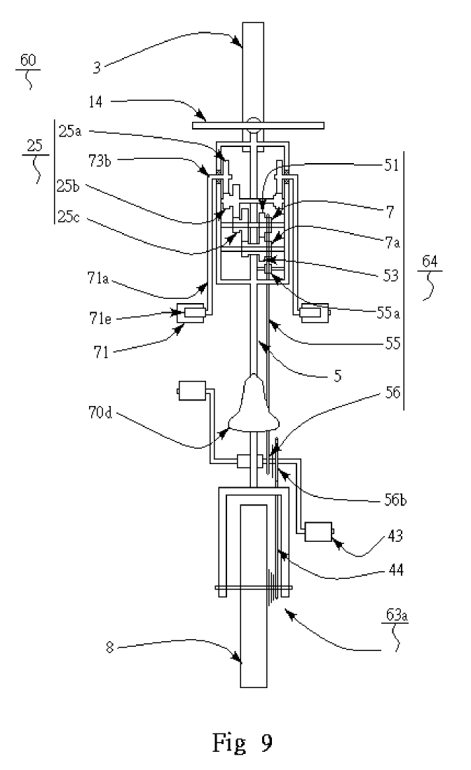

FIG. 5a shows two mashing gear 51 53, each has its own one-way sprocket 7, 7a in same direction respectively, a chain 55 encircles both sprocket 7, 7a and drives a driven sprocket 56 which finally drives rear wheel 8, idler 55a 55b are guiding idlers or insure engagement if needed; either 51 or 53 turns at either direction, one of sprocket (7 or 7a) will drive 56 at one direction only; this arrangement is extreme compact, less shaft needed, simple and easy to transmit longer distance; this is much suitable using a bicycle derailer device 63a as FIG. 9 shows. Said two one-way devices 7, 7a, each can be a bicycle freewheel, a ratchet or a one-way bearing, both at same one-way direction arrangement; they also can be used for vehicle coasting function.

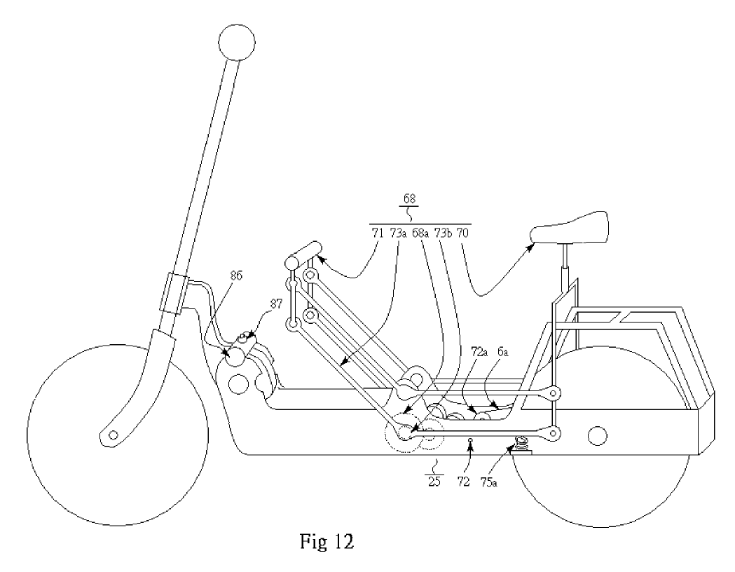

Said moving seat 70 can be any shape for user to sit, Refer to FIG. 4, moving seat connects at one end of seat-arm 70a on each side of chassis 5 which forms as a pair of seat-arm 70a for balance reason, another end of said seat-arm 70a solid connects to its pivotal shaft 70b which according to condition need, may goes through (as illustrated) on said chassis bearings and solid connects to another side of seat-arm 70a, or both side of seat-arm 70a solid connects to its own pivot shaft 70b which is supported by each side chassis bearing; one type of said moving seat is fixed on its seat-arm 70a as one body, and slanting following pivot center when turns (as FIG. 1 showed) which will help hip pushing angle; another type is keeping said moving seat 70 moving vertically all the time as FIG. 2 shown for a comfortable ride. Refer to FIG. 2, there are a pair of hinges above a pair of pivot shaft 70b, and two pair of hinges under moving seat 70 side and a pair of parallel bars above two seat-arm 70a, and make parallelogram all the time when seat-arm 70a turns, this make both side moving seat frame vertical all the time to provide moving seat 70 vertically when moving as FIG. 3 shows. FIG. 1 shows moving seat 70 is one part with seat-arm 70a, so whole seat angle changing according to gear 73c's center point. For a compact arrangement the seat can be detached from seat socket for easy storage as FIG. 12 shows. In order to keep smooth at end of swing stroke, there is a cushion spring 75a to keep seat comfortable during changing cycle.

Refer to FIG. 4, said treadle 71 connects at one end of treadle-arm 71a which is preferable (but not limit to) on each side of chassis and forms as a pair for balance reason, another end of treadle-arm 71a solid connects its pivotal shaft 71b which same condition as moving seat mentioned, goes through said chassis (not illustrated) or has its individual pivot support on each side of chassis according to situation need (as illustrated); one type of said treadle 71 is fixed on said treadle-arm 71a, and slant following pivot center when turns as FIG. 6 showed which help feet step down angle; another type keeps treadle moving vertical all the time as described parallelogram method for a comfortable ride as FIG. 12 shows. Treadle 71 can be a round bar, plate, platform, bicycle peddle or any shape, let feet step down and generate torque.

in order to reset cycle by each other, binding mechanism 73 links said pivotal shaft 70b, 71b by gears, linkages or sprockets and chain, and in a way makes a seesaw effect which reset each other on each cycle as FIG. 4 shown, also FIG. 2 shows gear 73c on pivot shaft 70b, a chain 73d to a gear set 73e then a gear 73f on pivot shaft 71b, this also makes a motion ratio adjustment between moving seat 70 and treadle 71, set a different ratio to get best comfortable working action balance because sitting a longer time on each cycle may more comfortable than standing.

Said treadle pivotal shaft 71b and moving seat pivotal shaft 70b are solid connected with its own leverage arm 70a, 71a and pivotal supported by bearings on chassis 5, also, one or both pivotal shafts contain said rocking driving means 68a to drive said increasing ratio device 25 or said change-direction mechanism 64; since both pivotal shafts 70b, 71b are separated and independently, the treadle treadle-arm 71a and moving seat seat-arm 70a can be setup rotates clockwise or counterclockwise direction independently, furthermore either one can be exist independently to simplify the structure; In case of only treadle portion exist with single one-way device 7, treadle can be reset by a return spring (not show) or by a foot hooking-bar 71e, which is a part of treadle, just above feet so when feet move up, it hook with foot moving up and reset cycle by foot; in case only moving seat exist, moving seat can be reset by a return spring so when standing action, spring pull moving seat up to reset cycle.

Said moving seat pivot shaft 70b and said treadle pivot shaft 71b can be combined as one pivotal shaft 73b and forms a seesaw beam 73a shape as prior art states, or seesaw beam 73a forms an angle (preferable between 120 to 180 degree) between two lever arms for a lower pivotal shaft application as FIG. 6 shows. Said seesaw beam 73a front end supports treadle 71, rear end supports moving seat 70, seesaw's single pivotal shaft 73b is supported by bearings (not illustrate) on said chassis 5.

FIG. 5 shows a rotating means by a section of a big gear 88 connecting behind seat frame drives a small gear 88a, which attach a bigger gear 88b and drives a chain 88c to said increasing gear ratio device 25; this is same effect as a big gear from pivot shaft 73b. FIG. 5 also indicates the way of changing rotation direction by two mashing gears, each gear with a one-way sprocket device; both on same check direction arrangement, so one gear driving sprocket causes chain forward while another one-way sprocket device at free rotation direction and allows its gear rotates backward during non-active cycle, and vice versa, and keep chain rotation always on forward direction, and drive derailer 63a to change speed. As for a pulling matter application, same as prior art, using a chains links under said treadle 71 and another chain links under moving seat 70, both chains been guided by some idlers to encircle inputs sprocket of said increasing ratio device 25 and the other end of each chain hold by a return spring (not illustrate) on said chassis.

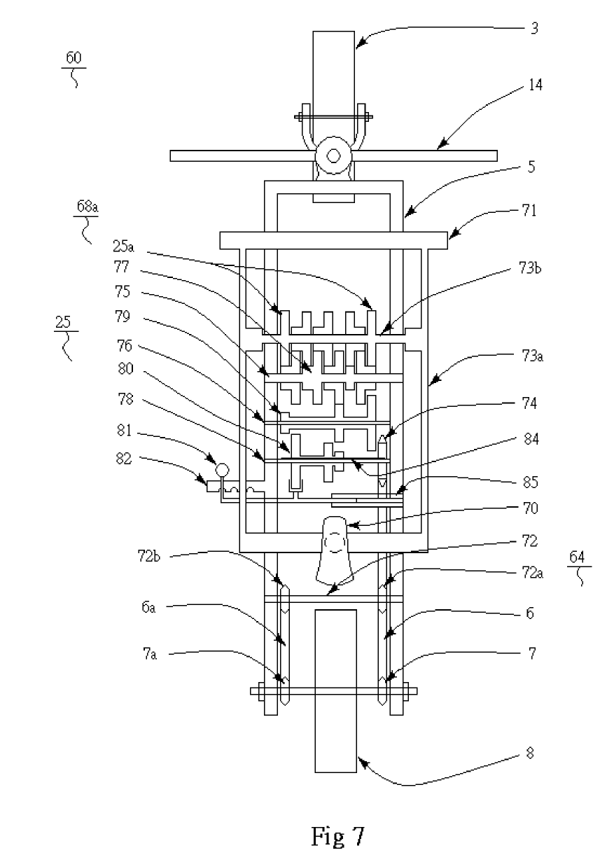

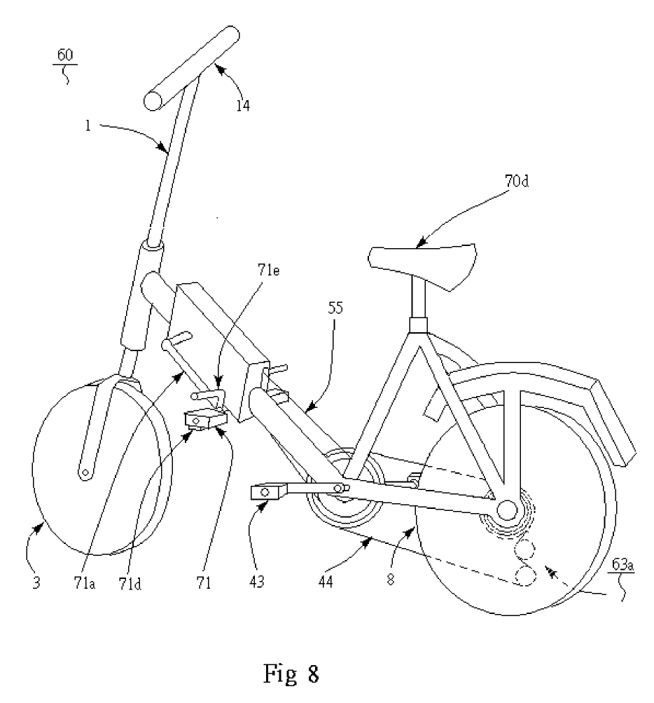

FIG. 4, 6, 7 shows only one example of many ways of increasing ratio, gear shifting and switch rotation method all together. Refer to FIG. 7 is a top view, FIG. 6 is a transparent side view for reference purpose; step down treadle 71 makes moving seat 70 rising up for next action seat cycle; since single pivotal shaft 73b solid connection with two input gear 25a, each connects in serial with two gear sets which free rotate on shaft, and then both drive shaft 77; this will take most of heavy load by doubling driving at same time. Gear 77 increases another partial of gear ratio again and finally meshes to long gear 79 which has 3 different gears as one part in a difference position for gear shifting. (One with 4 times gear width, another with 2 times gear width). Gear 79 mashes with gear 80 which has 3 different gears in one part with each in a difference location. (The biggest gear with 2 gear width). Gear 80 controlled by a fork on shifter 81. Different space makes one gear move out meshing before next gear engages in to avoid meshing 2 difference gear ratios at same time. Shifter 81 can be rest at pre-determine position by gear selector 82. There is a shaft sleeve 85 to keep shifter 81's shaft short to prevent stick out when shifting. Gear 80 drives a long key way 84 with sprocket 74 which drive one-way device 7. Distributing shaft 72 connects sprocket 72a and 72b. Since 72a engaging at outside of chain 6, it switches rotation direction and through chain 6a drives one-way device 7a. Both one-way devices are same direction to rear wheel and make 7a is driving forward and 7 is reversing and coasting. Same way works on hand-pushing and moving seat push down by body weight cycle, this makes pivot gear rotate in reverse direction, finally makes one-way device 7 drives rear wheel while one-way device 7a is reversing and coasting.

FIG. 8, FIG. 9 shows only treadle side exist on a fix seat 71e bicycle application, treadle 71 upper side has a hooking-bar 71e for foot to hook and raises up and reset stand-up cycle, there is a counterweight 71d at bottom of treadle to keep hook bar 71e stay at upper side to make foot easy access, when stand-up on treadle 71 increasing ratio device drive meshing gear type change-direction mechanism, make chain 55 drives derailer's big-sprocket set 56b, then use feet hook on hooking-bar 71e, use stomach and legs mussel pull treadle up while sit on fix seat 70d, and cycle continue.

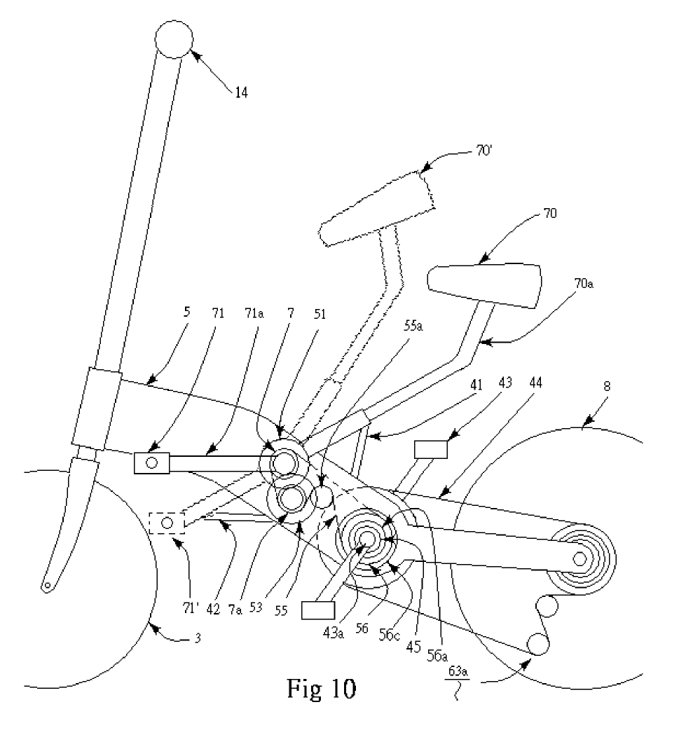

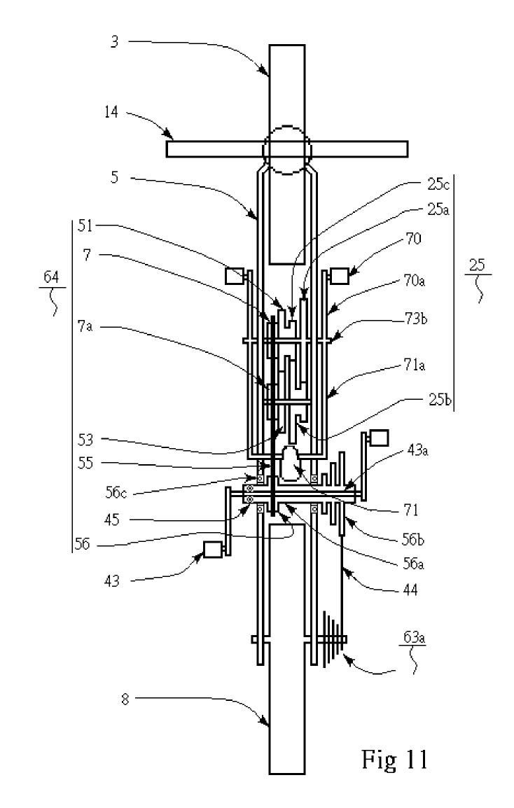

FIG. 10, 11 an example of a bicycle shows a see-saw type on this invention capable together with a regular peddling vehicle to have more selection on powering the vehicle; this allow user to select riding as a regular peddling or by body weight rocking action. Refer to FIG. 11, treadle and moving seat pivotal shaft 73b connects input gear 25a, which drives a free rotating gear set 25b, 25b meshes to a free rotating gear set 25c, 25c contains gear 51 which connects one-way device 52, gear 51 also meshes gear 53 which connects one-way sprocket 54, a chain 56 encircles two one-way device 52 54 together with a sprocket 56 on sprocket shaft 56a and keeping chain tension by an idler sprocket 55a; sprocket shaft 56a also contains big-sprocket set 56b of derailer device 63a, and via derailer chain 44 change speed and drives rear wheel 8; sprocket shaft 56a outside diameter contains two bearings 56c each bearing outside ring is supported by chassis 5 at both side, sprocket shaft 56a inside diameter contains one-way bearing 45, one-way driven by bicycle peddle shaft 43a and peddle 43, this one-way bearing 45 allows rocking device 68 overdrive sprocket shaft 56a while bicycle peddle 43 stay put or at reverse rotation. FIG. 10 shows position when moving seat 70 and treadle 71 reaches to stopper 41 position when end of pushing-sitting action, this position also is used for regular peddling position; the position of moving seat 70′ and treadle 71′ are anticipated position when end of pulling-standing-up action reaches to stopper 42 position.

FIG. 12 show a foldable front wheel assembly, pin 86 locks whole assembly on chassis 5 by two selectable positions and been secured by a nut 87.

This invention also can be add the suspension system, brake system on wheels, or lighting for street legal, folding front wheel mechanism as a kick scooter does.

What is claimed is:

1. A Push and Pull Vehicle by Stand-and-Sit Action, contains of:
a chassis;
a front wheel assembly with steering mechanism controlled by a handlebar at front end of said chassis;
a rear wheel assembly and rear wheel driven by two one-way device;
a rocking device on said chassis between front assembly and rear wheel assembly and contains a rocking driving means to drive an increasing ratio device and a change-direction mechanism which contains one forward one reverse direction driving on said two one-way device respectively; in which,
wherein said rocking device comprises of a treadle with a leverage by a treadle-arm which contains a pivotal shaft supported by said chassis, a moving seat with a leverage by a seat-arm which contains a pivotal shaft supported by said chassis, both pivotal shaft been connected each other which makes said treadle torque against said moving seat torque;
by grasp on said handlebar, do pull-stand on said treadle and push-sit to said moving seat and using pushing, pulling and body weight work on said rocking device and power said vehicle moving forward.

2. A Push and Pull Vehicle by Stand-and-Sit Action as claimed as claim 1, wherein said rocking driving means contains a rotating means on any of said pivotal shaft and connects to said increasing ratio device and change-direction mechanism.

3. A Push and Pull Vehicle by Stand-and-Sit Action as claimed as claim 1, wherein said rocking driving means contains one pulling matters links under said treadle and another pulling matter links under moving seat; both pull matters been guided by idlers to encircle inputs of said increasing ratio device and the other end of each said pulling matter hold by a return spring on said chassis.

4. A Push and Pull Vehicle by Stand-and-Sit Action as claimed as claim 1, wherein said treadle pivotal shaft and said moving seat pivotal shaft combine as one pivot shaft and forms a seesaw beam which has single pivotal shaft supported on said vehicle chassis; in which said seesaw beam front end contains said treadle, seesaw beam rear end contains said moving seat.

5. A Push and Pull Vehicle by Stand-and-Sit Action as claimed as claim 4, wherein said treadle-arm and seat-arm forms an angle from said single pivotal shaft.

6. A Push and Pull Vehicle by Stand-and-Sit Action as claimed as claim 1, wherein said seat-arm formed by a parallelogram linkage to keep said moving seat in a vertical manner all the time.

7. A Push and Pull Vehicle by Stand-and-Sit Action as claimed as claim 1, wherein said rocking device comprises of only treadle portion which contains treadle with treadle-arm and treadle-arm pivot.

8. A Push and Pull Vehicle by Stand-and-Sit Action as claimed as claim 1, wherein said rocking device comprises of only said moving seat portion which contains moving seat with seat-arm and seat-arm pivot.

9. A Push and Pull Vehicle by Stand-and-Sit Action as claimed as claim 1, wherein said wherein said change-direction mechanism by a disturbing shaft which contains two sprockets, one is driven by a driving chain from outside of chain loop, another sprocket transmits power by another chain from inside of chain loop.

10. A Push and Pull Vehicle by Stand-and-Sit Action as claimed as claim 1, wherein said change-direction mechanism by two meshing gears, each contains same direction one-way sprocket, a chain encircle said two one-way sprockets and an output sprocket which drives rear wheel.

11. A Push and Pull Vehicle by Stand-and-Sit Action as claimed as claim 1, wherein said rocking device apply on a derailer vehicle to make both rocking and peddling vehicle.

12. A Push and Pull Vehicle by Stand-and-Sit Action as claimed as claim 1, wherein said increasing ratio device contains more than one gear set which consist of one big and one small gear as a unit, and gear sets in serial connection by one set's big gear meshing with another set's small gear.

13. A Push and Pull Vehicle by Stand-and-Sit Action as claimed as claim 1, wherein said increasing ratio device including a bicycle a derailer device.
